(19) United States
(12) Patent Application Publication
(10) Pub. No.: US 2024/0047861 A1
(43) Pub. Date: Feb. 8, 2024

(54) SMALL CELL BEAMFORMING ANTENNAS SUITABLE FOR USE WITH 5G BEAMFORMING RADIOS AND RELATED BASE STATIONS

(71) Applicant: CommScope Technologies LLC, Hickory, NC (US)

(72) Inventors: Martin L. ZIMMERMAN, Chicago, IL (US); Zhiwei YIN, Suzhou (CN)

(21) Appl. No.: 17/761,731

(22) PCT Filed: Sep. 18, 2021
(86) PCT No.: PCT/CN2021/119258

§ 371 Date: Oct. 13, 2022

Related U.S. Application Data
(60) Provisional application No. 63/171,267, filed on Apr. 6, 2021.

(51) Int. Cl. H01Q 1/24; H01Q 3/28; H01Q 3/40; H01Q 19/10; H04L 5/14

(52) U.S. Cl. CPC H01Q 1/246; H01Q 3/28; H01Q 3/40; H01Q 19/10; H04L 5/14

(57) ABSTRACT

A small cell base station antenna includes a tubular reflector that has at least first through fourth faces that each face in different directions. The antenna further includes first through fourth arrays of radiating elements that are mounted on the respective first through fourth faces of the tubular reflector. The antenna also includes a passive beamforming network that has first through fourth outputs that are coupled to the respective first through fourth arrays of radiating elements.

### CROSS-REFERENCE TO RELATED APPLICATION

The present application claims priority to U.S. Provisional Patent Application Ser. No. 63/171,267, filed Apr. 6, 2021, the entire content of which is incorporated herein by reference as if set forth fully herein.

### FIELD

The present invention relates to cellular communications systems and, more particularly, to small cell base station antennas and related small cell base stations

### BACKGROUND

Cellular communications systems are well known in the art. In a typical cellular communications system, a geographic area is divided into a series of regions that are referred to as “cells,” and each cell is served by a “macrocell” base station. Each cell may, for example, have an area on the order of 1-50 km², with the cell size depending upon, among other things, the terrain and population density. The base station may include baseband equipment, radios and base station antennas that are configured to provide two-way radio frequency (“RF”) communications with fixed and mobile subscribers (“users”) that are positioned throughout the cell. The base station antennas are often mounted on a tower or other raised structure, with the radiation beam (“antenna beam”) that is generated by each antenna directed outwardly to serve the entire cell or a portion (“sector”) thereof. Typically, a base station antenna includes one or more phase-controlled arrays of radiating elements, with the radiating elements arranged in one or more vertical columns when the antenna is mounted for use. Herein, “vertical” refers to a direction that is generally perpendicular relative to the plane defined by the horizon.

In order to increase capacity, cellular operators have been deploying so-called “small cell” base stations. A small cell base station refers to a lower power base station that may operate in the licensed and/or unlicensed spectrum that serves a much smaller area than a typical macrocell base station. Herein, the term “small cell” is used broadly to refer to base stations that serve smaller areas than conventional macrocell base stations, and thus the term “small cell” encompasses small cell, microcell, picocell and other base stations that serve small geographic regions. Small cell base stations may be used, for example, to provide cellular coverage to high traffic areas within a macrocell, which allows the macrocell base station to offload much or all of the traffic in the vicinity of the small cell to the small cell base station.

FIG. 1 is a schematic diagram of a conventional small cell base station 10. The base station 10 includes an antenna 20 that may be mounted on a raised structure 30. In the depicted embodiment, the structure 30 is a monopole antenna tower, but it will be appreciated that a wide variety of mounting locations may be used including, for example, utility poles, buildings and the like. Typically, the antenna 20 of a small cell base station is designed to have an omnidirectional antenna pattern in the azimuth plane, meaning that the antenna beam generated by the antenna 20 may extend through a full 360° circle in the azimuth plane, and may have a suitable beamwidth (e.g., 10°-30°) in the elevation plane. The antenna beam may optionally be slightly down-tilted in the elevation plane (which may be a physical or electronic downtilt) to reduce spill-over of the antenna beam of the small cell base station antenna into regions that are outside the small cell and also for reducing interference between the small cell base station and the overlaid macrocell base station.

The small cell base station 10 further includes base station equipment such as one or more baseband units 40 and radios 42. The baseband unit 40 may receive data from another source such as, for example, a backhaul network (not shown) and may process this data and provide a data stream to the radio 42. The radio 42 may generate RF signals that include the data encoded therein and may amplify and deliver these RF signals to the antenna 20 for transmission via, for example, a cabling connection 44. While the radio 42 is shown as being co-located with the baseband equipment 40 at the bottom of the antenna tower 30, it will be appreciated that in other cases the radio 42 may be a remote radio head that is mounted on the antenna tower 30 adjacent the antenna 20. In some cases, the antenna may be a so-called “active antenna” that has the radio mounted directly on the antenna or implemented within the antenna. It will also be appreciated that the small cell base station 10 of FIG. 1 may typically include various other equipment (not shown) such as, for example, a power supply, back-up batteries, a power bus, controllers and the like.

Beamforming antennas are antennas that have multiple columns of radiating elements that are fed by corresponding ports of a beamforming radio. The beamforming radio may form a plurality of RF signals that are based on a baseband data stream and pass each of these RF signals to a respective output port of the radio (“radio port”). Each radio port is coupled to a different column of radiating elements of the multi-column array of radiating elements. The amplitude and phase of each RF signal may be set by the beamforming radio so that the columns of radiating elements work together to form a more focused, higher gain antenna beam that has a narrowed beamwidth in the azimuth plane. If the radiating elements in each column of the antenna are dual-polarized radiating elements, then the number of RF ports on the beamforming radio may be doubled, and the antenna may be configured to form a separate antenna beam for each polarization. The antenna beams may be changed on a time slot-by-time slot basis in a time division duplex (“TDD”) transmission scheme in order to electronically “steer” the antenna beams in the azimuth plane to point at or near the users served during each time slot (the pointing direction of an antenna beam refers to the direction where the antenna beam has peak gain). In other cases the antenna may be arranged so that there are multiple input ports for sub-arrays in the elevation direction as well as azimuth direction so that the antenna beam may be electronically steered and narrowed in both the azimuth and elevation planes. Since beamforming antennas have the ability to narrow the azimuth (and perhaps elevation) beamwidth and to scan the antenna beams in the directions of specific users, they may exhibit higher antenna gains and support increased capacity.

FIG. 2 is a collage of a top view, a side view and a partially cut-away perspective view of a conventional small cell beamforming antenna 50 that was designed to operate in 3G TD-SCMA systems. As shown in FIG. 2, the beamforming antenna 50 has eight columns (or linear arrays) 52 of vertically polarized radiating elements 54 that are arranged in an octagon around the circumference of a support structure 56. The linear arrays 52 are spaced sufficiently close together so that the antenna 50 can use beamforming techniques to feed multiple columns together to form narrowed antenna beams. A circular radome 58 is mounted over the support structure 56 and the linear arrays 52 to provide environmental protection. The individual radiating elements 54 have omnidirectional patterns, and hence the antenna 50 could not form high directivity antenna beams. Each linear array 52 of radiating elements 54 is driven at full power.

FIG. 3A is a schematic perspective view of another conventional small cell beamforming antenna 100 that was designed to operate in 4G Long Term Evolution (“LTE”) time division duplex (“TDD”) systems. The small cell beamforming antenna 100 of FIG. 3A is discussed in detail in U.S. Pat. No. 10,505,609, the entire content of which is incorporated herein by reference. As shown in FIG. 3A, the base station antenna 100 includes a tubular reflector assembly 110 having a rectangular cross-section. The base station antenna 100 includes four linear arrays 120-1 through 120-4 of dual-polarized radiating elements 122. Herein a “linear array” refers to a column of radiating elements that are connected to a common RF port (or two RF ports, if dual-polarized radiating elements are used) of an antenna. The radiating elements in a “linear array” need not be perfectly aligned (i.e., the term linear array encompasses arrays in which some or all of the radiating elements are staggered horizontally in order, for example, to narrow the azimuth beamwidth of the antenna beams formed by the linear array). Each linear array 120 is mounted on a respective one of the faces 112-1 through 112-4 of the reflector assembly 110 so that the radiating elements 122 extend outwardly from the respective faces 112, and so that each linear array 120 is oriented generally vertically with respect to the horizon when the base station antenna 100 is mounted for use. Each face 112 of the reflector assembly 110 may act as a reflector and as a ground plane for the dual-polarized radiating elements 122 mounted thereon. The base station antenna 100 further includes a radome 130 that covers and protects the radiating elements 122 and other components of the base station antenna 100.

FIG. 3B illustrates a feed network 150 of base station antenna 100, which is also disclosed in the above-referenced U.S. Pat. No. 10,505,609. The feed network 150 is used to pass RF signals between eight RF ports 144 on base station antenna 100 and the radiating elements 122 of the four linear arrays 120. FIG. 3B also illustrates the connections between the RF ports 144 on base station antenna 100 and the corresponding radio ports 44-1 through 44-8 of a conventional 4G beamforming radio 42.

As shown in FIG. 3B, the base station antenna 100 has eight RF ports 144-1 through 144-8. Ports 144-1 through 144-4 are coupled to the −45° dipole radiators of the radiating elements 122 of the respective linear arrays 120-1 through 120-4, and ports 144-5 through 144-8 are coupled to the +45° dipole radiators of the radiating elements 122 of the respective linear arrays 120-1 through 120-4. Each RF port 144 is coupled to an input of a respective phase shifter 180. Each phase shifter 180 splits the RF signals input thereto three ways and applies a phase progression across the three sub-components to apply an electronic downtilt to the antenna beam that is formed when the sub-components of the RF signal are transmitted (or received) through the respective linear arrays 120. The three outputs of each phase shifter 180 are coupled to either the −45° polarization transmission lines (for phase shifters 180-1 through 180-4) or the +45° polarization transmission lines (for phase shifters 180-5 through 180-8) on the three feedboards 128-1 through 128-3 of a respective one of the linear arrays 120. The transmission lines on each feedboard 128 include a power splitter (not shown) and the two Outputs of each such power splitter connect to either the −45° or the +45° polarization dipole radiators of the radiating elements 122 mounted on the respective feedboard 128.

The base station antenna 100 may operate in an LTE-TM8 beamforming mode in conjunction with an off-the-shelf 4^{th} Generation (4G) L eight-port beamforming radio 42. The radio 42 uses digital beamforming techniques to optimize the amplitude and phase weights that are applied to the signals received at each RF port 144 of the antenna 100. In particular, during a given time slot, an RF signal that is transmitted by the user assigned to the time slot is received at the antenna 100. This RF signal may be received at the radiating elements 122 of all four linear arrays 120-1 through 120-4. The magnitude and phase of the sub-components of the RF signal that are received at the radiating elements 122 of each linear array 120 will differ due to differences in transmission path lengths, fading, the azimuth pointing direction of each array and various other factors. Multiple versions of the transmitted RF signal may be received at one or more of the linear arrays 120 due to signal reflections off buildings, terrain features or the like that result in multipath transmission. The signals received at each of the eight linear arrays 120 are fed to the beamforming radio 42. The beamforming radio 42 uses an optimization algorithm to determine amplitude and phase weights to apply to the signals received at each linear array 120 that optimize a performance parameter (e.g., signal-to-noise ratio). The beamforming radio 42 applies the amplitude and phase weights determined by the optimization algorithm in demodulating the received RF signal. The beamforming radio 42 then determines the complex conjugates of the amplitude and phase weights that maximize the performance parameter for the received (uplink) signal and uses the complex conjugates as the amplitude and phase weights for transmitting RF signals through the linear arrays 120 on the downlink.

### SUMMARY

Pursuant to embodiments of the present invention, base station antennas are provided that include a tubular reflector that has at least first through fourth faces that face in different directions, first through fourth arrays of radiating elements that are mounted on the respective first through fourth faces of the tubular reflector, and a passive beamforming network that has first through fourth outputs that are coupled to the respective first through fourth arrays of radiating elements.

In some embodiments, the first face may be angled about 90° with respect to the second face.

In some embodiments, the tubular reflector may have a generally rectangular cross-section in a plane that is parallel to a plane defined by the horizon.

In some embodiments, the passive beamforming network may include a Butler Matrix.

In some embodiments, the base station antenna may be configured to provide omnidirectional coverage in the azimuth plane.

In some embodiments, the base station antenna may be provided in combination with a beamforming radio. The beamforming radio may include first through fourth first polarization ports that are coupled to respective first through fourth inputs of the passive beamforming network.

In some embodiments, the beamforming radio may be configured to operate using a time division duplex (“TDD”) communications scheme and may be configured to direct substantially all of the RF energy output by the first through fourth first polarization ports of the beamforming radio to a selected one of the arrays of radiating elements during selected time slots in a frame structure of the TDD communications scheme. In some embodiments, the beamforming radio may direct the RF energy output by the first through fourth first polarization ports to different ones of the first through fourth arrays of radiating elements during different time slots of the TDD communications scheme. In some embodiments, the beamforming radio may comprise an 8T/8R eight port beamforming radio.

In some embodiments, the first through fourth arrays of radiating elements may be respective first through fourth multi-column arrays of radiating elements, and the base station antenna may further include first through fourth power divider circuits that are each configured to split the RF energy output at a respective output of the passive beamforming network between the columns of the respective one of the first through fourth multi-column arrays of radiating elements that is coupled to the respective output of the beamforming network.

In some embodiments, an azimuth boresight pointing direction of the first array of radiating elements may be offset from the azimuth boresight pointing direction of the second through fourth arrays of radiating elements by about 90°, about 180° and about 270°, respectively.

In some embodiments, the first array of radiating elements may point in a first direction and the third array of radiating elements may point in a third direction that is substantially opposite the first direction. In some embodiments, the second array of radiating elements may point in a second direction and the fourth array of radiating elements may point in a fourth direction that is substantially opposite the second direction.

In some embodiments, the amplitude and phase weights of the beamforming radio may be set in a manner that will configure the first through fourth arrays of radiating elements to generate antenna beams having any of a sector antenna pattern, a heart-shaped antenna pattern, a bi-directional antenna pattern and an omni directional antenna pattern in the azimuth plane.

Pursuant to further embodiments of the present invention, base stations are provided that include a beamforming radio having a plurality of first polarization radio ports, a base station antenna that includes a plurality of arrays of radiating elements, and a passive beamforming network coupled between the first polarization radio ports and the arrays of radiating elements. The beamforming radio is configured to adjust the amplitude and/or phase of the RF signals output at each first polarization radio port in order to direct substantially all of the RF energy output through the first polarization radio ports to a selected one of the arrays of radiating elements.

In some embodiments, the base station antenna may further include a reflector assembly that includes a first face and a second face that is angled by about 90° with respect to the first face, and a first of the arrays of radiating elements may be mounted on the first face and a second of the arrays of radiating elements may be mounted on the second face.

In some embodiments, the passive beamforming network may include a plurality of four-port couplers.

In some embodiments, the beamforming radio may be an 8T/8R eight port beamforming radio.

In some embodiments, the beamforming radio may be configured to operate using a time division duplex (“TDD”) communications scheme and may be configured to direct substantially all of the RF energy output through the first polarization radio ports to different ones of the arrays of radiating elements during different time slots.

In some embodiments, the base station antenna may be configured to provide omnidirectional coverage in the azimuth plane.

Pursuant to still further embodiments of the present invention, methods of operating a cellular base station are provided. The base station includes a reflector assembly having arrays of radiating elements mounted to extend outwardly from respective faces of the reflector assembly that face in different directions. First RF signals are transmitted through a plurality of ports of a beamforming radio to a passive beamforming network during a first time slot, where the beamforming radio sets amplitudes and phases of the first RF signals so that substantially all of the RF energy is passed to a first of the arrays of radiating elements.

In some embodiments, the method further comprises transmitting second RF signals through the plurality of ports of the beamforming radio to the passive beamforming network during a second time slot, where the beamforming radio sets amplitudes and phases of the second RF signals so that substantially all of the RF energy is passed to a second of the arrays of radiating elements.

In some embodiments, the beamforming radio may he an 8T/8R eight port beamforming radio.

In some embodiments, the beamforming radio may be configured to set the amplitudes and phases of RF signals generated by the beamforming radio to one of four different settings.

In some embodiments, the reflector assembly may have a generally rectangular cross-section in a plane that is parallel to the plane defined by the horizon.

In some embodiments, the passive beamforming network may include a Butler Matrix.

In some embodiments, the reflector assembly may include first through fourth faces and the arrays of radiating elements may include first through fourth arrays of radiating elements that are mounted on the respective first through fourth faces.

In some embodiments, the first face may be angled from the second through fourth faces by about 90 degrees, about 180 degrees and about 270 degrees, respectively.

In some embodiments, the first through fourth arrays of radiating elements may be respective first through fourth multi-column arrays of radiating elements, the base station antenna further comprising first through fourth power divider circuits that are each configured to split the RF energy output at a respective output of the passive beamforming network between the columns of the respective one of the first through fourth multi-column arrays of radiating elements that is coupled to the respective output of the beamforming network.

Pursuant to further embodiments of the present invention, base stations are provided that include a beamforming radio having first through fourth first polarization radio ports, a base station antenna that includes first through fourth arrays of radiating elements, and a passive beamforming network that couples each of the first through fourth first polarization radio ports to all four of the first through fourth arrays of radiating elements.

In some embodiments of these base stations, the base station antenna may include a tubular reflector assembly that has first through fourth faces that are each angled by about 90° with respect to adjacent ones of the first through fourth faces. The first through fourth arrays of radiating elements may be mounted on the respective first through fourth faces.

In some embodiments, the passive beamforming network may include at least one four-port coupler. For example, in some embodiments, the passive beamforming network may include four four-port couplers per polarization.

In some embodiments, the amplitude and phase weights of the beamforming radio may be set in a manner that will configure the first through fourth arrays of radiating elements to generate antenna beams having any of a sector antenna pattern, a heart-shaped antenna pattern, a bi-directional antenna pattern and an omni directional antenna pattern in the azimuth plane.

In some embodiments, the beamforming radio may be an 8T/8R eight port beamforming radio.

### BRIEF DESCRIPTION OF THE DRAWINGS

FIG. 1 is a highly simplified schematic diagram illustrating a conventional small cell base station.

FIG. 2 is a collage including a schematic front view, a schematic top view and a partially cut-away schematic perspective view of a conventional beamforming small cell base station antenna.

FIG. 3A is a schematic shadow perspective view of another conventional small cell beamforming antenna that is suitable for use in 4G LTE-TDD systems.

FIG. 3B is a block diagram illustrating the feed network of the conventional base station antenna of FIG. 3A.

FIG. 4A is a partial perspective view of a small cell beamforming antenna according to embodiments of the present invention with the radome and top end cap removed.

FIGS. 4B and 4C are a side view and a top view, respectively, of two of the radiating elements included in the base station antenna of FIG. 4A mounted on a feedboard.

FIG. 4D is a block diagram illustrating a feed network that may be included in the base station antenna of FIG. 4A.

FIG. 4E is a block diagram illustrating another feed network that may be included in the base station antenna of FIG. 4A.

FIG. 5A is a schematic top view of a small cell beamforming antenna according to further embodiments of the present invention.

FIG. 5B is a block diagram illustrating a feed network that may be included in the base station antenna of FIG. 5A.

FIGS. 5C and 5D are schematic top views of small cell beamforming antennas according to additional embodiments of the present invention.

FIG. 6 is a schematic diagram of a small cell beamforming antenna according to still further embodiments of the present invention.

FIG. 7 is a flow chart diagram illustrating a method of operating a base station antenna according to embodiments of the present invention.

FIGS. 8A-8D are graphs illustrating the azimuth patterns of additional antenna beams that may be formed by the small cell beamforming antenna according to embodiments of the present invention.

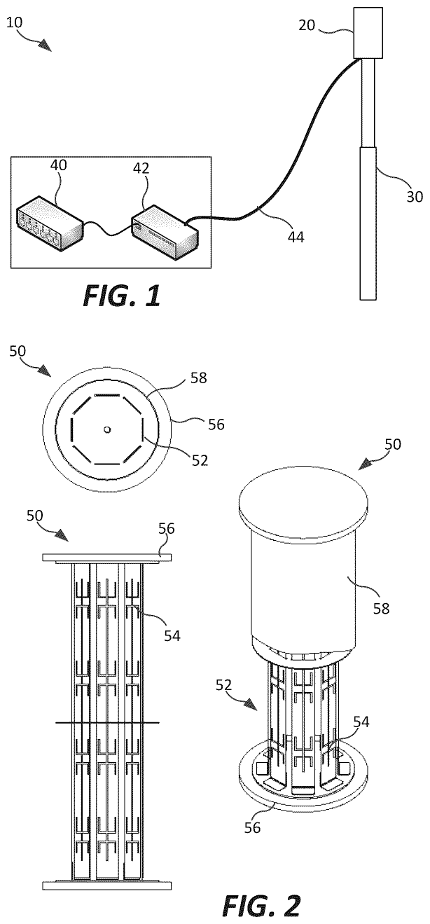

When multiple instances of an element are present, the individual elements may be referred to in the drawings using two-part reference numerals (e.g., 220-2). Herein, the full reference numeral is used to refer to a specific element (e.g., linear array 220-2), while the first part of the reference numeral may be used to refer to all of the elements collectively (e.g., the linear arrays 220).

### DETAILED DESCRIPTION

With the introduction of 5^{th} generation (“5G”) cellular systems, beamforming antennas are now widely being deployed. Most of these antennas are so-called “panel” antennas that are designed to provide coverage throughout a 120° sector of a base station. These antennas typically include multiple linear arrays of radiating elements and one or more multi-column arrays of radiating elements, all of which are mounted on a planar reflector. The linear arrays of radiating elements may be designed to generate static antenna beams that cover the full 1200 sector. In contrast, the multi-column arrays are designed to work with beamforming radios in order to generate more focused antenna beams that have higher antenna gain and that can be electronically steered to cover different portions of the 120° sector. For example, so-called 8T/8R beamforming radios have been developed that are routinely used with four column multi-column arrays. These 8T/8R radios have a total of eight radio ports, with four of the radio ports coupled to the −45° radiators of the radiating elements in the four columns (one radio port per column) of the multi-column array and the other four of the radio ports coupled to the +45° radiators of the radiating elements in the remaining four columns (one radio port per column) of the multi-column array. The radio and the four column array can simultaneously generate a pair of antenna beams, namely one at each polarization. The 8T/8R beamforming radio sets the amplitude and phase of the RF signals output through each radio port so that the generated antenna beams (1) have reduced beamwidths in the azimuth plane, and hence higher antenna gain and (2) are electronically steered in the azimuth plane to point in a desired direction. The 8T/8R beamforming radio may, for example, change the pointing direction of the generated antenna beams on a time slot-by-time slot basis of a TDD communication scheme.

While these 8T/8R 5G radios are well-suited for use with panel antennas that only cover, for example, a 120° sector of a cell, these radios are not well suited for use with antennas that provide omnidirectional (i.e., 360°) or quasi-omnidirectional coverage in the azimuth plane. Most small cell antennas, however, are designed to provide omnidirectional or quasi-omnidirectional coverage in the azimuth plane. Thus, 8T/8R 5G radios are not designed to be used in conjunction with most small cell antennas.

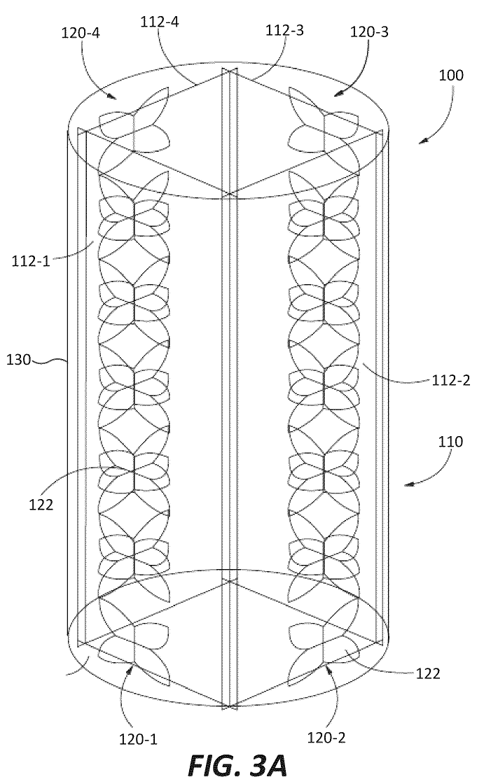

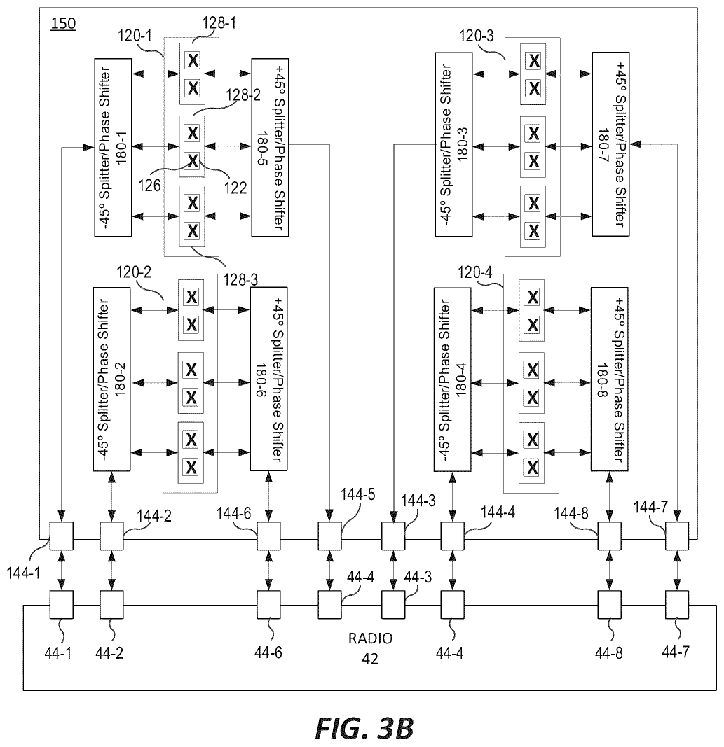

One option for providing beamforming small cell base stations is to use the beamforming antenna 100 discussed above with respect to FIGS. 3A-3B in conjunction with a 4G radio. Another solution would be to use the antenna of FIG. 3A with a 5G radio that was programmed to perform beam-switching. In this configuration, the 5G radio would determine, based on feedback from the user devices, the radio ports that provide the best channel quality indicator for each time slot. The 5G radio would then use only the identified radio ports for each time slot to transmit and receive RF signals. However, with this technique only two or four of the radio ports would be used (or have magnitudes above a de minimis level) during any given time slot. Since each radio port is coupled to a separate transceiver, this means that less than 50% of the radio transmit power would be used during any given time slot, and most typically only about 25% of the radio transmit power. Thus, while this technique will work, the effective isotropic radiated power (“EIRP”) from the small cell base station will be 3-6 dB below the EIRP that would be available if all of the radio ports were used during each time slot.

Pursuant to embodiments of the present invention, small cell beamforming base station antennas are provided that are suitable for use with 5G TDD radios that may use substantially all of the transmit power of the radio. These antennas may have passive beamforming networks that route the RF signals received from each radio port to a desired subset of the linear arrays included in the antenna. The small cell beamforming antennas according to embodiments of the present invention may have a very small form factor and may be mounted on light posts, electric power poles, telephones poles and the like. These small cell beamforming antennas may generate directional radiation patterns during any given time slot while providing full 360° coverage in the azimuth plane. The small cell antennas according to embodiments of the present invention may support higher EIRP levels than conventional small cell beamforming systems.

In some embodiments, the beamforming antennas according to embodiments of the present invention may include four linear arrays of radiating elements that are mounted on the four main faces of a tubular reflector assembly having a generally rectangular horizontal cross-section. The azimuth boresight pointing direction of each linear array (i.e., the direction where the antenna beams formed by the linear array achieve peak gain when no electronic steering is applied) may be offset from the azimuth boresight pointing direction of the remaining three linear arrays by about 90°, about 180° and about 270°, respectively. The radiating elements in each linear array may comprise dual-polarized radiating elements such as, for example, slant −45°/+45° cross-dipole radiating elements. The radiating elements may have directional patterns in the azimuth plane having, for example, azimuth half power beamwidths of between 50°-100°. Each of the four linear arrays may connect to two RF ports (one for each polarization) on the antenna, and the eight RF ports may connect to corresponding radio ports on an eight-port 5G 8T/8R beamforming radio. Each linear array may form a pair of directional antenna beams, one for each orthogonal polarization. Each antenna beam may, for example, provide coverage for about 90° in the azimuth plane.

In some embodiments, the small cell base station antenna may use passive beamforming networks such as a 4×4 Butler Matrix to combine the RF signals output through the four radio ports associated with one of the polarizations and to then output the combined signal through one of four output ports of the beamforming network to form a “sector” antenna beam that, for example, provides coverage to a 90° sector in the azimuth plane. The radio may set the amplitude and phase weights on the RF signals output from each radio port in one of four ways. Each of the four different weight settings act to direct all of the RF energy output at the four radio ports of the beamforming radio to a selected one of the four linear arrays. In other words, the 5G beamforming radio and the passive beamforming network may be configured to work together to feed the signals output by four radio ports to a selected one of the four linear arrays. This may be done for each of the two polarizations so that all of the RF energy output by the 5G-radio during any given time slot may be radiated through a selected one of the four linear arrays. The radio may optionally be programmed to use two of the linear arrays during time slots serving users that are at the overlapping edges of the coverage areas of two adjacent arrays.

Moreover, by adjusting the weight settings, antenna beams having other shapes and/or pointing directions may be formed. For example, all of the RF energy output at the four radio ports of the beamforming radio may be directed to two adjacent ones of the linear arrays instead of to a single linear array. This technique may be used to change the boresight pointing direction of the sector antenna beam so that the peak gain of the sector antenna beam may be pointed at any angle in the azimuth plane. The beamforming antennas according to embodiments of the present invention may also be configured to form antenna beams having other shapes simply be changing the weight settings. For example, the above-described antennas may be configured to form antenna beams having omnidirectional, heart-shaped and/or bi-directional patterns in the azimuth plane simply by applying the appropriate weight settings in the beamforming radio. Thus, a single beamforming antenna, in conjunction with an off-the-shelf 5G beamforming radio, may form any of the standard antenna patterns that are typically desired by cellular operators.

Butler Matrix based beamforming networks are conventionally used to couple multiple radio ports to a multi-column planar array of radiating elements. For example, the Butler Matrix may be used to allow two radio ports to share a multi-column array of radiating elements so that each radio port is coupled to all of the radiating elements in the array. The Butler Matrix is typically configured to couple the two radio ports to the multi-column array in such a way that the RF signal from the first radio port generates a first antenna beam that points in a first direction in the azimuth plane and the RF signal from the second radio port generates a second antenna beam that points in a second, different, direction in the azimuth plane. Such antennas are typically used in sector splitting applications where the first antenna beam covers a first portion of a sector of a base station (e.g., the left side of a 120° sector) and the second antenna beam covers a second portion of the sector (e.g., the right side of the 120° sector). Embodiments of the present invention use Butler Matrix style beamforming networks in a completely different way the Butler Matrix acts as a power combiner and as a switch that allows all of the output power of the radio to be delivered to a selected one of the linear arrays of the antenna.

According to further embodiments of the present invention, the base station antenna may include switching networks that accomplish the same result. For example, base station antennas are provided that include four linear arrays of radiating elements that are mounted on the four main faces of a tubular reflector assembly having a generally square horizontal cross-section. These antennas further include, for each polarization, a 4×1 combiner and a 1×4 switch. Each 4×1 combiner is coupled to the four radio ports of the 5G beamforming radio that are associated with one of the two supported polarizations. The output of each 4×1 combiner is coupled to a respective one of the 1×4 switches, and the outputs of each 1×4 switch are coupled to the respective linear arrays. Each 1×4 switch may be set to route RF signals received at the input thereof to a selected one of the four linear arrays on a time slot-by-time slot basis in order to combine the RF signals output through four of the radio ports and output the combined signal through the selected one of the linear arrays.

In some applications the antennas according to embodiments of the present invention that include Butler Matrix-style feed networks may be preferred over antennas that use RF switches in the feed network, as the Butler Matrix-style approach may have superior power handling capabilities and better passive intermodulation distortion performance.

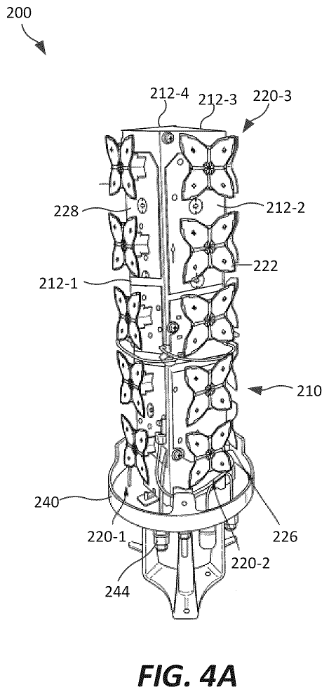

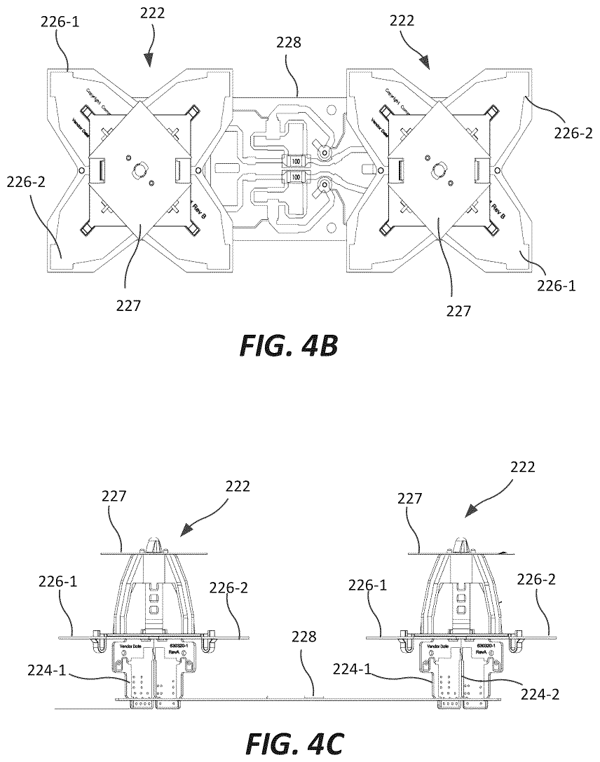

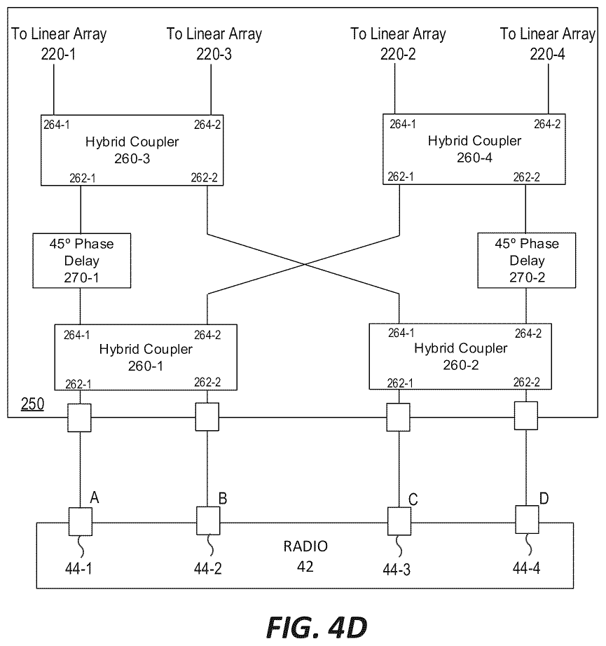

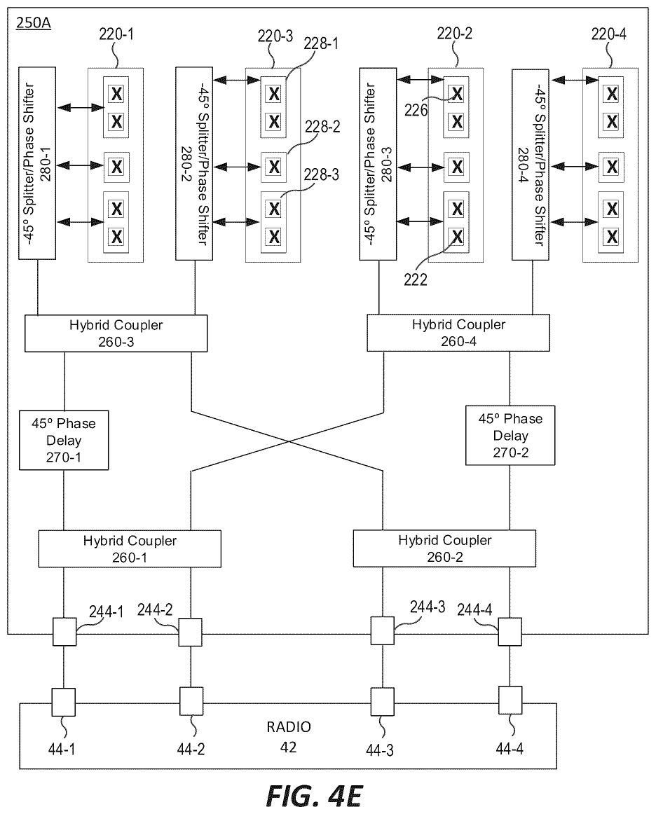

Embodiments of the present invention will now be discussed in further detail with reference to FIGS. 4A-7.

FIG. 4A is a perspective view of a beamforming base station antenna 200 according to embodiments of the present invention (with the radome and top end cap thereof removed) that is suitable for use as a small cell base station antenna. As shown in FIG. 4A, the small cell base station antenna 200 includes a rectangular tubular reflector assembly 210 having four faces 212-1 through 212-4. Four linear arrays 220-1 through 220-4 of dual-polarized. radiating elements 222 are mounted to extend outwardly from the respective faces 212 of the reflector assembly 210 (the fourth linear array 220-4 is not visible in FIG. 4A, but may be identical to the other linear arrays 220 except that it points in a different direction). The rectangular tubular reflector assembly 210 may comprise a unitary structure or may comprise a plurality of structures that are attached together. Each face 212 thereof may act as reflector and as a ground plane for the dual-polarized radiating elements 222 of the linear arrays 220 mounted thereon.

A plurality of RF ports 244 are mounted in a bottom end cap 240 of base station antenna 200. A total of eight RF ports 244-1 through 244-8 may be provided, with two RF ports 244 coupled to each linear array 220. The first RF port 244 coupled to each linear array 220 may support communications at the first polarization and the second RF port 244 coupled to each linear array 220 may support communications at the second polarization.

Each linear array 220 may be oriented generally vertically with respect to the horizon when the base station antenna 200 is mounted for use so that each linear array 220 comprises a column of radiating elements 222. In the depicted embodiment, each linear array 220 includes a total of five radiating elements 222. It will be appreciated, however, that other numbers of radiating elements 222 may be included in the linear arrays 220. In the depicted embodiment, each linear array 220 is implemented as three sub-arrays of radiating elements 222, where the top and bottom sub-arrays include two radiating elements 222 that are mounted on a common feedboard 228, while the middle sub-array includes a single radiating element 222 that is mounted on its own feedboard 228. It will be appreciated that any appropriate number of radiating elements 222 may be included in each sub-array, and that feedboards 228 may or may not be used. It will also be appreciated that different types of radiating elements 222 may be used than those depicted in FIGS. 4A-4C. The base station antenna 200 further includes a radome and top end cap (not shown) that cover and protect the radiating elements 222 and other components of the base station antenna 200.

Each radiating element 222 may be implemented, for example, using the radiating element design shown in FIGS. 4B-4C. As shown in FIGS. 4B and 4C, each radiating element 222 may comprise a pair of stalks 224-1, 224-2 and a pair of radiators 226-1, 226-2. Each stalk 224 may comprise a microstrip printed circuit board. The two printed circuit boards that form the stalks 224-1, 224-2 may be arranged in an “X” configuration. Each radiator 226 may comprise, for example, a dipole radiator that has first and second dipole arms. Each dipole radiator 226 may have a directional pattern in the azimuth plane having, for example, azimuth half power beamwidths of between 45°-65°. In the depicted embodiment, the base station antenna 200 is a dual-polarized antenna, and hence each radiating element 222 includes a pair of dipole radiators 226 arranged in a so-called “cross-dipole” arrangement, with the first dipole radiator 226 being disposed at an angle of −45° from a vertical axis, and the second dipole radiator 226 being disposed at an angle of +45° from the vertical axis. Each dipole radiator 226 may be disposed in a plane that is substantially perpendicular to a longitudinal axis of its corresponding stalk 224. In some embodiments, both dipole radiators 226-1, 226-2 may be formed on a common printed circuit board. In FIGS. 4B-4C, each sub-array includes a pair of radiating elements 222 that are mounted on a feedboard 228. The feedboard 228 may be configured to split an RF signal (the split need not be equal) that is provided thereto into two sub-components and to feed each sub-component to a respective one of the radiating elements 222. The feedboard 228 may include two inputs, namely one for each polarization. Directors 227 may be mounted above the dipole radiators 226 to narrow the beamwidth of the radiating elements 222.

As discussed above, the small cell base station antennas according to embodiments of the present invention may use beamforming networks such as, for example, Butter Matrices, to combine the RF signals output by the beamforming radio and to route the combined RF signal to a selected one of the linear arrays of the antenna. In this manner, the full transmit power of the radio may be utilized and the RF signal may be directed to a selected linear array.

FIG. 4D is a simplified circuit diagram of a feed network 250 according to embodiments of the present invention that may be used to pass RF signals between four first polarization RF ports 244 of base station antenna 200 and the first polarization dipole radiators 226 of the radiating elements 222 of the four linear arrays 220. FIG. 40 also illustrates the connections between the RF ports 244 and the corresponding radio ports 44-1 through 44-8 on a conventional beamforming radio 42. The beamforming radio 42 may be an 8T/8R 5G beamforming radio. FIG. 4D only illustrates the radio ports 44, RF ports 244 and feed network 250 for one of the two polarizations supported by base station antenna 200 (e.g., the −45° polarization). It will be appreciated that the elements shown in FIG. 4D would be repeated for the second polarization.

As shown in FIG. 4D, the feed network comprises four hybrid couplers 260-1 through 260-4 and a pair of 45° phase delays 270. Each hybrid coupler 260 may comprise, for example, a four-port 90° hybrid coupler that has first and second input ports 262-1, 262-2 and first and second output ports 264-1, 264-2. As known in the art, a four-port 90° hybrid coupler that receives signals “A” and “B” at the two input ports 262-1, 262-2 thereof and outputs signals having magnitude A/2+B/2 at each output port 264-1, 264-2, with a phase difference between the two output signals of 90°. The 45° phase delays 270 may comprise, for example, delay lines or more complex phase delay structures that may provide improved performance (i.e., a consistent phase delay) over wider frequency ranges. It will also be appreciated that one or more of the 90° hybrid couplers could be replaced with a 180° coupler in conjunction with a delay line.

As shown in FIG. 40, the inputs 262-1, 262-2 of the first hybrid coupler 260-1 are coupled to first and second ports 44-1, 44-2 of the 5G beamforming radio 42 and the inputs 262-1, 262-2 of the second hybrid coupler 260-2 are coupled to third and fourth ports 44-3, 44-4 of SG beamforming radio 42. The first output 264-1 of the first hybrid coupler 260-1 is coupled to the input of the first 45° phase delay 270-1 and the second output 264-2 of the first hybrid coupler 260-1 is coupled to the first input 262-1 of the fourth hybrid coupler 260-4. The output of the first 45° phase delay 270-1 is coupled to the first input 262-1 of the third hybrid coupler 260-3. The first output 264-1 of the second hybrid coupler 260-2 is coupled to the second input 262-2 of the third hybrid coupler 260-3 and the second output 264-2 of the second hybrid coupler 260-2 is coupled to the input of the second 45° phase delay 270-2. The output of the second 45° phase delay 270-2 is coupled to the second input 262-2 of the fourth hybrid coupler 260-4.

The RF signals output from the first output port 264-1 of the third hybrid coupler 260-3 are coupled to the −45° dipole radiators 226 of the radiating elements 222 of the first linear array 220-1. The RF signals output from the second output port 264-2 of the third hybrid coupler 260-3 are coupled to the −45° dipole radiators 226 of the radiating elements 222 of the third linear array 220-3. The RF signals output from the first output port 264-1 of the fourth hybrid coupler 260-4 are coupled to the −45° dipole radiators 226 of the radiating elements 222 of the second linear array 220-2. The RF signals output from the second output port 264-2 of the fourth hybrid. coupler 260-4 are coupled to the −45° dipole radiators 226 of the radiating elements 222 of the fourth linear array 220-4.

As a result of the above connections, assuming that a signal “A” is output from radio port 44-1, a signal “B” is output from radio port 44-2, a signal “C” is output from radio port 44-3, and a signal “D” is output from radio port 44-4, the phases of the sub-components of signals A-D that are received at linear arrays 220-1 through 220-4 are as follows:
Linear Array 220-1: A+45°; B+125°; C+90°; D+180°
Linear Array 220-2: A+90°; B+0°; C+225°; D+135°
Linear Array 220-3: A+135°; B+275°; C+0°; D+90°
Linear Array 220-4: A+180°; B+90°; C+135°; D+45°

TABLE 1 below shows the amplitude and phases of the RF signals input to feed network 250 (i.e., the amplitude and phase settings applied in the beamforming radio 42) that will result in all of the RF energy being directed to a single linear array 220.

TABLE 1

| Radio Port | Radio Port | Radio Port | Radio Port | RF Energy | Peak Beam |
|---|---|---|---|---|---|
| 44-1 | 44-2 | 44-3 | 44-4 | Output | Position |
| 0.5/−45° | 0.5/−135° | 0.5/−90° | 0.5/−180° | 220-1 | 0° |
| 0.5/−90° | 0.5/−0° | 0.5/−225° | 0.5/−135° | 220-4 | 270° |
| 0.5/−135° | 0.5/−225° | 0.5/0° | 0.5/−90° | 220-3 | 180° |
| 0.5/−180° | 0.5/−90° | 0.5/−135° | 0.5/−45° | 220-2 | 90° |

Focusing on, for example, the first row of TABLE 1, it can be seen that when radio ports 44-1 through 44-4 are fed signals having magnitude/phases of 0.5/−45°, 0.5/−135°, 0.5/−90°, 0.5/−80°, respectively, then the RF power at each linear array 220 is as follows:
Array 220-1=1
Array 220-2=0.5/45°+0.5/−135°+0.5/135°+0.5/−45°=0
Array 220-3=0.5/90°+0.5/90°+0.5/−90°+0.5/−90°=0
Array 220-4=0.5/135°+0.5/−45°+0.5/45°+0.5/−135°=0

In other words, by programming the 8T/8R beamforming radio 42 to apply appropriate amplitudes and phases to the RF signals output on the four ports for the first polarization, the small cell base station antenna 200 may be configured to output all of the RF energy to linear array 220-1. The same technique may be applied to direct all of the RF energy to the second linear array 220-2, the third linear array 220-3 or the fourth linear array 220-4 by simply using opposite signs on the phases for the signals output at each radio port 44.

TABLE 1 thus shows that by using the beamforming radio 42 to appropriately amplitude and phase weight the RF signals provided to radio ports 44-1 through 44-4, all of the RF energy transmitted through those radio ports 44 may be directed to a selected one of the four linear arrays 220. Thus, by using the passive beamforming network 250, the full capabilities of the 8T/8R beamforming radio 42 may be utilized (and, in particular, the full RF power of each transmit/receive chain) and the RF energy may be transmitted through a selected one of the linear arrays 220 to provide a directional, high gain antenna beam.

While not shown in FIG. 40, the base station antenna 200 may also have a calibration port that is used to determine the relative magnitudes and phases of RF signals that are transmitted along each path through the feed network so that differences in the levels of attenuation and phase shift along each RF path may be determined and the radio 42 may account for these differences when generating the amplitude and phase weights that are applied to the RF signals output at each radio port 44.

As shown above, the base station antenna 200 may have a four-beam beam set, and the radio 42 may be programmed to select one of the four antenna beams for each time slot based on one or more channel quality indicators for the user(s) served during the time slot. Since the base station antenna 200 has dual-polarized radiating elements 222, the selected linear array 220 generates two antenna beams during each time slot, allowing the small cell base station antenna 200 to operate as a 2T/2R (2×MIMO) beamforming antenna.

It will be appreciated that FIG. 40 illustrates one specific design for a Butler Matrix. A wide variety of different Butler Matrix designs may be used, and the radio 42 may appropriately adjust the amplitude and phases of each input signal to route the RF energy to the selected linear array 220. It will also be appreciated that beamforming networks other than Butler Matrices may be used in some embodiments.

In many cases, it may be desirable to have the ability to electronically downtilt the antenna beams generated by a base station antenna. FIG. 4E is a schematic diagram of a feed network 250A that has remote electronic downtilt capabilities. The feed network 250A of FIG. 4E may be used in place of feed network 250 of FIG. 40.

As shown in FIG. 4E, the feed network 250A is similar to feed network 250 in that it includes the four hybrid couplers 260-1 through 260-4 and the 45° phase delays 270-1, 270-2. As the arrangement and operation of these elements has been described above, repeated description thereof will be omitted.

The feed network 250A further includes four power splitter/phase shifter assemblies 280-1 through 280-4. Each phase shifter 280 may be configured to split the RF signals input thereto three ways (and the power split may be equal or unequal) and to apply a phase progression across the three sub-components of the split RF signal to apply an electronic downtilt to the antenna beam that is formed when the sub-components of the RF signal are transmitted (or received) through the linear array 220 that is connected to the outputs of the power splitter/phase shifter assembly 280. As described above with reference to FIG. 4D, the three outputs of each phase shifter 280 are coupled to the 45° polarization transmission lines on the three feedboards 2284 through 228-3 of the respective linear arrays 220. The −45° polarization transmission lines on feedboards 228-1, 228-3 include a power splitter (not shown) and the two outputs of each such power splitter connect to the respective −45° polarization radiators 226 of the radiating elements 222 of the respective feedboards 228. Thus, the RF signals output at each output port 264 of the third and fourth hybrid couplers 260-3, 260-4 are split into several sub-components and then phase shifted, and the phase shifted sub-components are split again and fed to the five −45° polarization dipole radiators 226 of the linear array 220 coupled to the respective output port 264. The power splitting may be equal or unequal power splitting. The number of phase shifter outputs may be different than three.

It will be appreciated that FIG. 4E, like FIG. 4D, only shows the feed network for one of the two polarizations. It will be appreciated that the elements shown in FIG. 4E would be repeated for the second polarization. It will also be appreciated that the phase shifters 280 may be omitted in some embodiments, and the RF signals may be split on the feedboards 228 and coupled to the radiating elements 222. It will likewise be appreciated that the feedboards 228 may be omitted in some embodiments and that the radiating elements may be directly fed by RF cables. For example, if die-cast metal dipole radiators are used as the radiating elements, the dipole radiators may be directly fed by coaxial cables in example embodiments. Thus, it will be appreciated that any appropriate feed network and radiating elements may be used, including feed networks that directly feed each radiating element without the use of any feedboards. While FIG. 4E illustrates an embodiment in which one or two radiating elements 222 are mounted per feedboard 228, it will be understood that any number of radiating elements 222 may be provided per feedboard 228 (e.g., three, four, etc.). For example, in another embodiment, all five radiating elements 222 of each linear array 220 may be provided on a single feedboard 228 that could include the phase shifters 280 for both polarizations, while in other embodiments each radiating element 222 could be implemented on its own feedboard 228.

The base station antenna 200 thus comprises a tubular reflector 210 that has at least first through fourth faces 212-1 through 212-4 that each face in different directions. The antenna 200 further includes first through fourth arrays 220-1 through 220-4 of radiating elements 222 that are mounted on the respective first through fourth faces 212-1 through 212-4 of the tubular reflector 210. The antenna 200 also includes a passive beamforming network 260-1 through 260-4, 270-1, 270-2 that has first through fourth outputs that are coupled to the respective first through fourth arrays of radiating elements 220-1 through 220-4.

The base station antenna 200 may be relatively small, having a diameter on the order of 8 inches and a height of about two feet for an antenna operating in the 2 GHz frequency range. Such an antenna may be readily mounted on most utility poles and streetlights, and given its small diameter, the antenna 200 may blend together with the pole so that it is not a visual blight. Moreover, in urban environments, there are typically a small number of entities that own the utility poles such as an electric power company, a government entity e.g., for streetlights), and a landline telephone company. As such, deploying small cell base station antenna that are utility pole mountable—such as the base station antenna 200—may be advantageous since a cellular operator can reach a leasing agreement with one or two entities to obtain locations for mounting small cell base station antennas throughout the urban area.

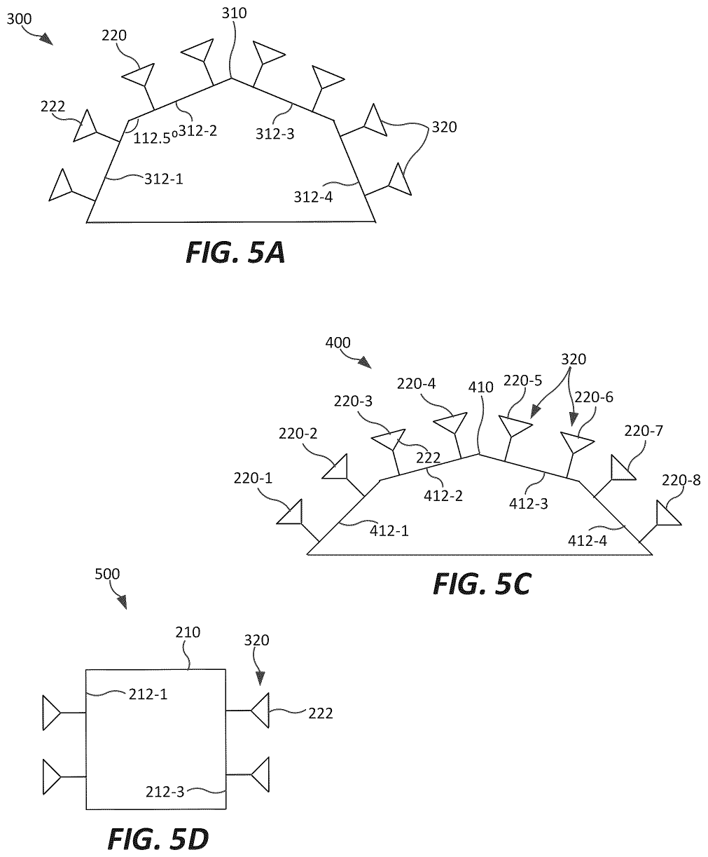

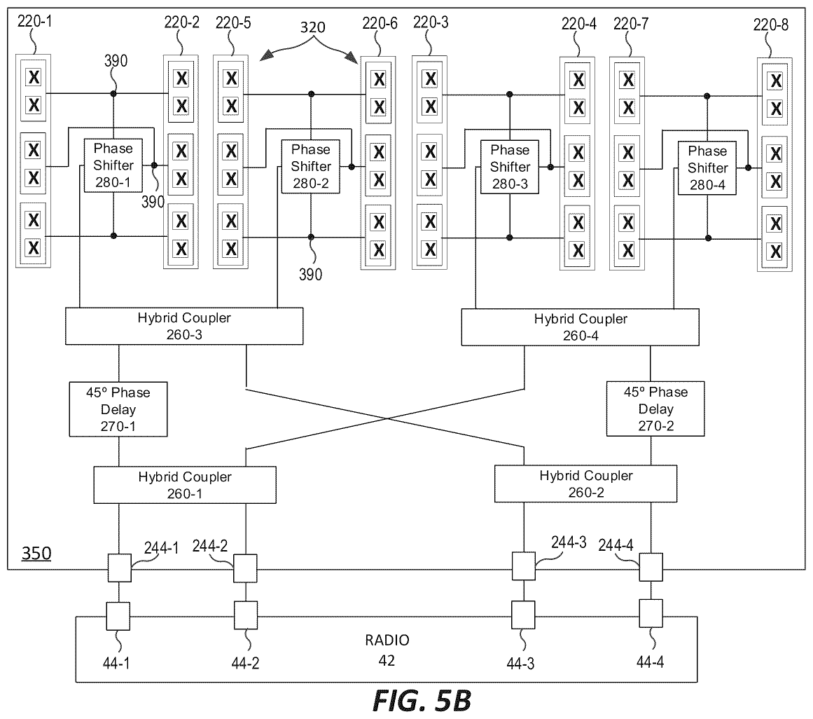

FIG. 5A is a schematic top view of a small cell beamforming antenna 300 according to further embodiments of the present invention. As shown in FIG. 5A, the base station antenna 300 includes a reflector assembly 310 that has four faces 312-1 through 312-4 and an optional back wall that together define a semi-octagonal tube. Two column arrays 320 of dual-polarized radiating elements 222 are mounted in side-by-side fashion to extend outwardly from each face 312 of the reflector assembly 310. Each two-column array 320 may include two linear arrays 220 that each include six radiating elements 222. As FIG. 5A is a schematic top view of the base station antenna 300, only the top radiating element 222 of each linear array 220 is visible in the figure. Each face 312 of the reflector assembly 310 may act as reflector and as a ground plane for the dual-polarized radiating elements 222 mounted thereon.

FIG. 5B is a block diagram illustrating a feed network 350 that may be included in the base station antenna 300 of FIG. 5A. The feed network for base station antenna 300 may be almost identical to the feed network 250A illustrated in FIG. 4E. The primary differences between feed network 250A and feed network 350 are (1) feed network 350 is designed to feed six radiating elements per linear array rather than five radiating elements and (2) in feed network 350 each output of each phase shifter 280 is coupled to a 1×2 power divider 390 that splits the RF signal. The first output of each 1×2 power divider 390 is coupled to one of the feedboards 228 of the first linear array 220 on the face 312 and the second output of each 1×2 power divider 390 is coupled to one of the feedboards 228 of the second linear array 220 on the face 312. In this fashion, each phase shifter 280 may feed both linear arrays 220 on a face 312, so that the two linear arrays 220 act together as a multi-column array 320 to form an antenna beam having a narrowed beamwidth in the azimuth plane. It will be appreciated that FIG. 5B only shows the feed network 350 for one polarization. The feed network 350 thus would be duplicated to feed the second polarization radiators of each radiating element 222 in the linear arrays 220.

The base station antenna 300 may be suitable for providing coverage over a 180° area in the azimuth plane. The base station antenna 300 may, for example, be mounted on an exterior wall of a building. In other embodiments, the tubular reflector assembly 310 having a semi-octagonal horizontal cross-section of FIG. 5A may be replaced with a tubular reflector assembly having a full octagonal horizontal cross-section, and eight additional linear arrays 220 may be provided, with two linear arrays 220 mounted on each of the four additional faces of the tubular reflector assembly. Such a base station antenna may be operated with two 8T/8R radios or with a single 16T/16R radio.

While base station antenna 200 (FIGS. 4A-4E) supports full 360° coverage area in the azimuth plane and base station antenna 300 (FIGS. 5A-5B) supports full 180° coverage area in the azimuth plane, it will be appreciated that embodiments of the present invention are not limited thereto. Instead, small cell base station antennas may be provided that are designed to cover any contiguous portion or multiple non-contiguous portions in the azimuth plane. For example, as shown in FIG. 5C, in another embodiment, a small cell base station antenna 400 may be provided that is designed to serve a 120°coverage area. As shown in FIG. 5C, the small cell base station antenna 400 may include a reflector assembly 410 having four faces 412-1 through 412-4. A two (or three) column array 320 of radiating elements 222 may be mounted on each face 412 of the reflector assembly 410. Referring to FIG. 5D, as another example, a small cell base station antenna 500 may be provided that has a four-sided tubular reflector assembly 210, but which has arrays 320 of radiating elements 222 only mounted on two opposed faces 212-1, 212-3 of the tubular reflector assembly 210, Each array 320 may be a multi-column array having, for example, two (or three) columns of radiating elements 222. The radiating elements 222 in each column may be commonly fed in the same manner shown in FIG. 5B. The base station antenna 500 may be particularly well-suited for use in tunnels, on bridges and/or on long, straight highways. Since arrays are only provided on two of the four faces 212 of the reflector assembly 210, base station antenna 500 may be operated with a 4T/4R. TTD 5G beamforming radio.

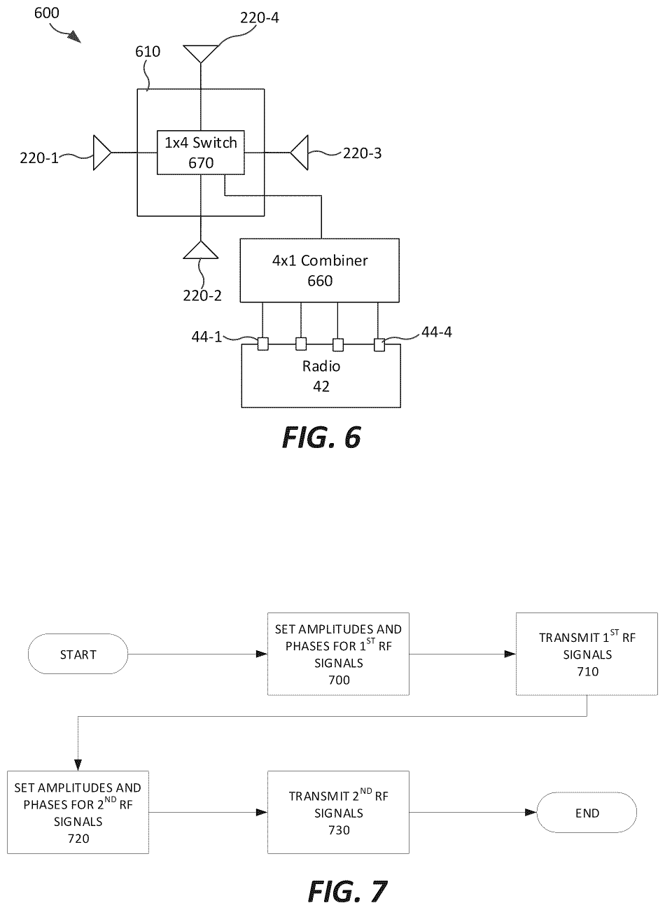

FIG. 6 is a schematic diagram of a base station that includes a beamforming radio 42 and a small cell beamforming antenna 600 according to still further embodiments of the present invention. The small cell beamforming antenna 600 uses a 4×1 power combiner 660 and a 1×4 switch 670 to implement functionality similar to the beamforming network 250 of FIG. 4D. It will be appreciated that FIG. 6 only illustrates the radio ports 44 and feed network for the first of two orthogonal polarizations. Thus, the radio 42 may include four additional second polarization ports, and a second 4×1 combiner 660 and a second 1×4 switch 670 may be provided that connect the four second polarization radio ports 44 to the second polarization radiators 226-2 of the radiating elements 222 in the four linear arrays 220.

The base station 600 may operate as follows. The beamforming radio 42 may output the same RF signal at each first polarization radio port 44. These RF signals are then combined by the 4×1 combiner 660 into a composite RF signal. The composite RF signal output by the combiner 660 is fed to the 1×4 switch 670 that passes the composite RF signal to the first polarization radiators of a selected one of the four linear arrays 220. The 1×4 switch 670 may select one of the four arrays 220 for each time slot in a TDD communications scheme based on a determination as to which array 220 will support communications having the highest channel quality indicator (which may be determined based on feedback from the user device(s) that are served during each time slot). Thus, the base station antenna 600 may operate in the same manner as the base station antenna 200 described above, but uses a combiner 660 and a switch 670 to select the linear array 221) that is fed during a particular time slot rather than a passive beamforming network as is the case with base station antenna 200. It should be noted that while not shown in FIG. 6, the feed network for base station antenna 600 may further include phase shifters in order to provide remote electronic downtilt capabilities. The four outputs of the 1×4 switch 670 in FIG. 6 could be coupled to the linear arrays 220 through four phase shifters 280 in the same manner that the four outputs of hybrid couplers 260-3 and 260-4 are coupled to the linear arrays 220 through phase shifters 280 as shown in FIG. 4E, so further discussion of this modification to FIG. 6 will not be repeated here.

FIG. 7 is a flow chart diagram illustrating a method of operating a small cell base station according to embodiments of the present invention. The small cell base station includes a TDD beamforming radio and a small cell base station antenna that includes a plurality of arrays of dual-polarized radiating elements, where at least two of the arrays have different azimuth boresight pointing directions. As shown in FIG. 7, operations may begin with the beamforming radio setting amplitudes and phases of first RF signals (Block 700). The amplitudes and phases may be set so that substantially all of the RF energy of the first RF signals is passed to a first of the arrays of radiating elements. Then the first RF signals may be transmitted through a plurality of ports of the beamforming radio to a passive beamforming network during a first time slot (Block 710). Thereafter, the beamforming radio may set amplitudes and phases of second RF signals (Block 720). The amplitudes and phases may be set so that substantially all of the RF energy of the second RF signals is passed to a second of the arrays of radiating elements that is different from the first of the arrays of radiating elements. Then the second RF signals may he transmitted through a plurality of ports of the beamforming radio to a passive beamforming network during a second time slot (Block 730). Thus, the beamforming radio may use its beamforming capabilities to make the passive beamforming network operate as a switch.

In some embodiments, the TDD beamforming radio may split the energy between different layers of a multi-input-multi-output (“MIMO”) transmission scheme, serving multiple user devices at the same time with different antenna beams. For example, the radio may support 4×MIMO communications by forming two different antenna beams (at each polarization) using different amplitude/phase weights at the RF level.

It will also be appreciated that the small cell base stations according to embodiments of the present invention, such as the small cell base station of FIG. 4D that includes base station antenna 200, may be configured to output the RF energy to more than a single linear array 220 in order to generate antenna beams having additional shapes. When all of the RF energy that is output through the four radio ports 44-1 through 44-4 of beamforming radio 42 is passed to a single linear array 220, the antenna beam may be a so-called “sector” antenna beam that is designed to cover, for example, a 90° sector in the azimuth plane. Such an antenna beam may have a HPBW in the azimuth plane suitable for covering the 90° sector an azimuth HPBW of about 45°) and an elevation HPBW (and electronic downtilt in the elevation plane) suitable for providing coverage to the sector. By appropriately amplitude and phase weighting the RF signals output by the 8T/8R radio 42, a cellular operator may form antenna beams that cover any one of four 90° quadrants in the azimuth plane, where all of the RF energy output by the radio 42 is used to form each antenna beam.

Moreover, by adjusting the weight settings that are applied in the 8T/8R radio 42, the pointing direction of the sector antenna beam may be adjusted. For example, all of the RF energy output at the four radio ports 44-1 through 44-4 of the beamforming radio 42 may be directed to two adjacent ones of the linear arrays 220 of base station antenna 200 instead of to a single linear array 220. This technique may be used to change the boresight pointing direction of the sector antenna beam so that the peak gain of the sector antenna beam may be pointed at any angle in the azimuth plane.

Additionally, in some situations, a cellular operator may want to generate antenna beams having shapes other than a “sector” shape. For example, in order to transmit control signals to all users within a coverage area of the base station antenna, the cellular operator may want to generate an antenna beam that has omnidirectional coverage in the azimuth plane. By amplitude and phase weighting the RF signals output at radio ports 44-1 through 44-4 in the manner shown in TABLE 2 below, an antenna beam having generally omnidirectional coverage in the azimuth plane may he generated.

TABLE 2

| Radio Port | Radio Port | Radio Port | Radio Port |
|---|---|---|---|
| 44-1 | 44-2 | 44-3 | 44-4 |
| 0.5/−45° | 0.5/−135° | 0.5/−135° | 0.5/−45° |

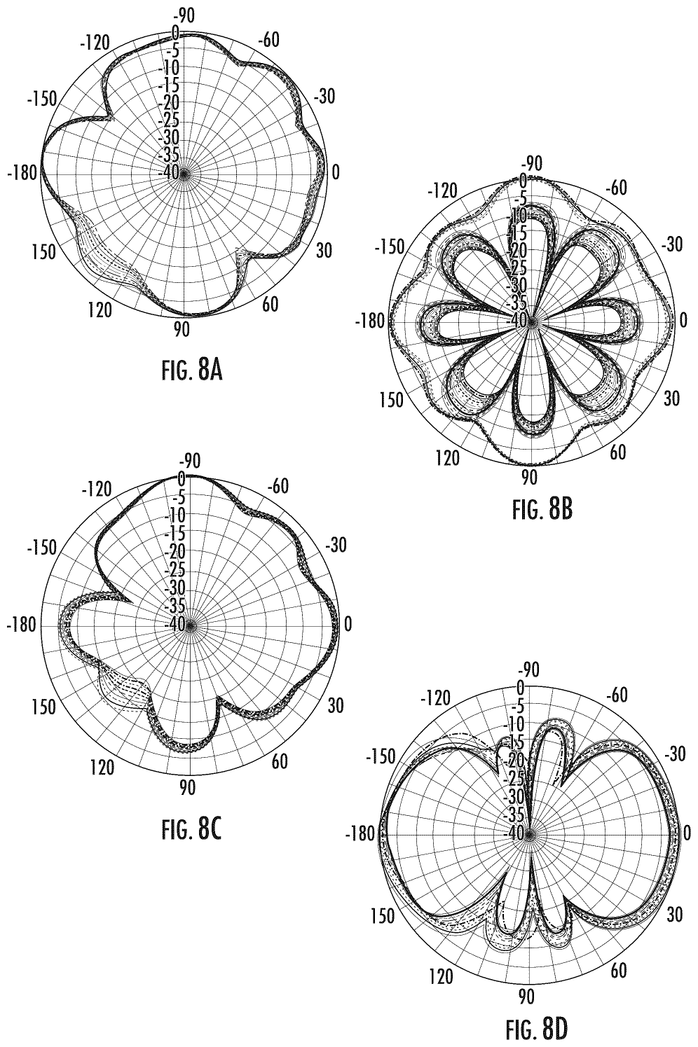

FIG. 8A is a graph illustrating the azimuth pattern of the omnidirectional antenna beam that is generated when the base station antenna 200 of FIGS. 4A-4D is excited using the beamforming weights shown in TABLE 2. As can be seen, the antenna beam generally has an omnidirectional shape, although the antenna beam exhibits a fairly high degree of ripple (i.e., variation in gain as a function of pointing angle), and the pattern includes two relatively deep nulls (each is about 15 dB below peak gain), It has been determined that if all four ports of the Butler Matrix based feed network 250 are instead excited with RF signals having the same phase, the omnidirectional antenna beam that is generated may exhibit decreased ripple, as shown in FIG. 8B. Thus, the base station antenna 200 may be configured to generate omnidirectional antenna beams (e.g., for service beams) simply by appropriately weighting the RF signals output at each radio port 44 of the beamforming radio 42.

Cellular operators are also sometimes interested in deploying base station antennas that generate so-called “heart-shaped” antenna beams that provide coverage over approximately 180° in the azimuth plane. The base station antennas according to embodiments of the present invention can also readily form such heart-shaped antenna beams by, for example, amplitude and phase weighting the RF signals output at radio ports 44-1 through 44-4 in the manner shown in TABLE 3 below.

TABLE 3

| Radio Port | Radio Port | Radio Port | Radio Port |
|---|---|---|---|
| 44-1 | 44-2 | 44-3 | 44-4 |
| 0.5/−45° | 0.5/−45° | 0.5/−45° | 0.5/−45° |

The amplitude and phase weights shown in TABLE 3 will send all of the RF energy to first and second adjacent ones of the linear arrays 220 in order to form an antenna beam having a heart-shape in the azimuth plane. It will also be appreciated that the amplitude and phase weights may be adjusted from what is shown in TABLE 3 to select which pair of adjacent linear arrays 220 are excited to form the heart-shaped antenna beam, so that the pointing direction of the peak of the heart shaped antenna beam may be rotated to point in different directions. Moreover, the pointing direction of the heart-shaped antenna beam may also be adjusted to point in any direction in the azimuth plane by directing the RF energy to three of the linear arrays 220 with appropriate amplitude and phase weights applied by the beamforming radio 42.

FIG. 8C is a graph illustrating the azimuth pattern of a heart-shaped antenna beam that may be generated when the base station antenna 200 of FIGS. 4A-4D is excited using the beamforming weights shown in TABLE 3.

Cellular operators are also sometimes interested in deploying base station antennas that generate so-called “bi-directional” antenna beams that provide coverage in two opposed directions in the azimuth plane. Antenna beams having a bi-directional shape in the azimuth plane may be useful, for example, in providing coverage to long fairly straight sections of highways and/or along bridges, tunnels and the like. The base station antennas according to embodiments of the present invention can also readily form such “bi-directional” antenna beams by, for example, amplitude and phase weighting the RF signals output at radio ports 44-1 through 44-4 in the manner shown in TABLE 4 below.

TABLE 4

| Radio Port | Radio Port | Radio Port | Radio Port |
|---|---|---|---|
| 44-1 | 44-2 | 44-3 | 44-4 |
| 0.5/−113° | 0.5/−207° | 0.5/−254° | 0.5/−335° |

The amplitude and phase weights shown in TABLE 4 will send all of the RF energy to first and second opposed ones of the linear arrays 220 in order to form an antenna beam having a heart-shape in the azimuth plane. It will also be appreciated that the amplitude and phase weights may be adjusted from what is shown in TABLE 4 to select which pair of opposed linear arrays 220 are excited to form the heart-shaped antenna beam, so that the pointing direction of the peak of the heart shaped antenna beam may be rotated to point in different directions.

FIG. 8D is a graph illustrating the azimuth pattern of a bi-directional antenna beam that may be generated when the base station antenna 200 of FIGS. 4A-4D is excited using the beamforming weights shown in TABLE 4.

Moreover, the amplitude and phase weights may be further adjusted so that the pointing direction of the peak of the various antenna beams that are discussed above that provide less than omnidirectional coverage in the azimuth plane i.e., the 90° sector beams, the heart-shaped 180° sector beams and the bi-directional antenna beams) may point in any direction in the azimuth plane.

As illustrated above, the small cell beamforming base station antennas according to embodiments of the present invention can generate all of the standard antenna beams (omnidirectional, sector, heart-shaped, bi-directional) that cellular operators request for small cell antennas in a single antenna, and may do so while using the full transmit power of the cellular radio. Using conventional techniques, such a capability may only be obtained by providing four different small cell antenna designs where each design is configured to form a specific one of the antenna beams. In short, by using a standard, off-the-shelf 8T/8R beamforming radio a cellular operator may now use the same antenna to generate any of the standard antenna beams.

It will be appreciated that many modifications may be made to the antennas described above without departing from the scope of the present invention. For example, the base station antenna 200 includes four linear arrays 220 that are mounted on the four sides of a support structure that has a square horizontal cross-section. In other embodiments, a base station antenna may be provided that is identical to the base station antenna 200 except that it includes five linear arrays that are mounted on a support structure having a pentagon-shaped horizontal cross-section. Such a base station antenna may be used with a 10T/10R 5G beamforming radio. In still other embodiments, a base station antenna may be provided that is identical to the base station antenna 200 except that it includes six linear arrays that are mounted on a support structure having a hexagonal horizontal cross-section. Such a base station antenna may be used with a 12T/12R 5G beamforming radio. As another example, small cell base station antennas may be provide that have a tubular reflector assembly that has a substantially octagonal horizontal cross-section, with a linear array mounted on each of the eight faces of the tubular reflector assembly. Such a base station antenna may be used in conjunction with two 8T/8R beamforming radios to effectively implement an antenna that is equivalent to two of base station antenna 200 in a single housing. Assuming the eight faces of the tubular reflector assembly are numbered as faces 1-8 in order, then the linear arrays on faces 1, 3, 5 and 7 may be used with the first beamforming radio and the linear arrays on faces 2, 4, 6 and 8 may be used with the second beamforming radio. Such an approach may be used to implement higher order MIMO communications or to provide service in two different frequency bands.

The present invention provides small cell base station antennas that can be used with 8T/8R (or other) 5G radios while harnessing all of the output power of the radio. This may be important as 8T/8R radios may be the only 5G radios that are available for use in certain of the 5G frequency bands such as the C-band (3.7-3.98 GHz). Such 8T/8R radios are not well-suited for use with conventional small cell antennas. The present invention provides base station antennas that take advantage of the beamforming capabilities of the 8T/8R radios to generate higher gain antenna beams while simultaneously using the full transmit power of all eight channels of the radio for each user.

The present invention has been described above with reference to the accompanying drawings. The invention is not limited to the illustrated embodiments; rather, these embodiments are intended to fully and completely disclose the invention to those skilled in this art. In the drawings, like numbers refer to like elements throughout. Thicknesses and dimensions of some elements may not be to scale.

Spatially relative terms, such as “under”, “below”, “lower” ; “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

1. A base station antenna, comprising:
a tubular reflector that has at least first through fourth faces that face in different directions;
first through fourth arrays of radiating elements that are mounted on the respective first through fourth faces of the tubular reflector; and
a passive beamforming network that has first through fourth outputs that are coupled to the respective first through fourth arrays of radiating elements,
in combination with a beamforming radio, wherein the beamforming radio includes first through fourth first polarization ports that are coupled to respective first through fourth inputs of the passive beamforming network.

2. (canceled)

3. The base station antenna of claim 1, wherein the tubular reflector has a generally rectangular cross-section in a plane that is parallel to a plane defined by the horizon.

4. The base station antenna of claim 1, wherein the passive beamforming network includes a Butler Matrix.

5-6. (canceled)

7. The base station antenna of claim 1, wherein the beamforming radio operates using a time division duplex (“TDD”) communications scheme and is configured to direct substantially all of the RF energy output by the first through fourth first polarization ports of the beamforming radio to a selected one of the arrays of radiating elements during selected time slots in a frame structure of the TDD communications scheme.

8. The base station antenna of claim 7, wherein the beamforming radio directs the RF energy output by the first through fourth first polarization ports to different ones of the first through fourth arrays of radiating elements during different time slots of the TDD communications scheme.

9. The base station antenna of claim 1, wherein the beamforming radio comprises an 8T/8R eight port beamforming radio.

10. The base station antenna of claim 1, wherein the first through fourth arrays of radiating elements comprise respective first through fourth multi-column arrays of radiating elements, the base station antenna further comprising first through fourth power divider circuits that are each configured to split the RF energy output at a respective output of the passive beamforming network between the columns of the respective one of the first through fourth multi-column arrays of radiating elements that is coupled to the respective output of the beamforming network.

11.-13. (canceled)

14. A base station, comprising:
a beamforming radio having a plurality of first polarization radio ports;
a base station antenna that includes a plurality of arrays of radiating elements; and
a passive beamforming network coupled between the first polarization radio ports and the arrays of radiating elements,
wherein the beamforming radio is configured to adjust the amplitude and/or phase of the RF signals output at each first polarization radio port in order to direct substantially all of the RF energy output through the first polarization radio ports to a selected one of the arrays of radiating elements.

15. The base station of claim 14, wherein the base station antenna further comprises a reflector assembly that includes a first face and a second face that is angled by about 90° with respect to the first face, wherein a first of the arrays of radiating elements is mounted on the first face and a second of the arrays of radiating elements is mounted on the second face.

16. The base station of claim 14, wherein the passive beamforming network includes a plurality of four-port couplers.

17. The base station of claim 16, wherein the beamforming radio comprises an 8T/8R eight port beamforming radio.

18. The base station of claim 14, wherein the beamforming radio operates using a time division duplex (“TDD”) communications scheme and is configured to direct substantially all of the RF energy output through the first polarization radio ports to different ones of the arrays of radiating elements during different time slots.

19. The base station of claim 14, wherein the base station antenna is configured to provide omnidirectional coverage in the azimuth plane.

20-39. (canceled)

40. A base station, comprising:
a beamforming radio having first through fourth first polarization radio ports; and
a base station antenna that includes first through fourth first polarization connector ports and a passive beamforming network that includes first through fourth inputs that are coupled to the respective first through fourth first polarization connector ports,
wherein the first through fourth first polarization radio ports are coupled to the respective first through fourth first polarization connector ports.

41. The base station of claim 40, the base station antenna further comprising first through fourth linear arrays of radiating elements, wherein the passive beamforming network further includes first through fourth outputs that are coupled to the respective first through fourth linear arrays of radiating elements.

42. The base station of claim 41, wherein the first through fourth linear arrays face in respective first through fourth different directions.

43-44. (canceled)

45. The base station of claim 41, wherein by setting amplitude and phase weights of the beamforming radio the first through fourth arrays of radiating elements can be configured to generate antenna beams having any of a sector antenna pattern, a heart-shaped antenna pattern, a bi-directional antenna pattern and an omni directional antenna pattern in the azimuth plane.

46. The base station of claim 40, wherein the beamforming radio comprises an 8T/8R eight port beamforming radio.

47. (canceled)
